(19) United States
(12) Patent Application Publication
(10) Pub. No.: US 2014/0322392 A1
(43) Pub. Date: Oct. 30, 2014

(54) SNACKS WITH MARBLED-LIKE APPEARANCE AND METHODS FOR STEAM TREATING DOUGH-BASED SNACKS

(71) Applicants: Meagan Caroline Haskins, Ringwood, NJ (US); Vani Vemulapalli, Whippany, NJ (US); Jan Karwowski, Franklin Lakes, NJ (US)

(72) Inventors: Meagan Caroline Haskins, Ringwood, NJ (US); Vani Vemulapalli, Whippany, NJ (US); Jan Karwowski, Franklin Lakes, NJ (US)

(21) Appl. No.: 14/342,513

(22) PCT Filed: Sep. 7, 2012
(86) PCT No.: PCT/US2012/054188

§ 371 Date: May 22, 2014

Related U.S. Application Data
(60) Provisional application No. 61/533,075, filed on Sep. 9, 2011.

(51) Int. Cl. A23L 1/164; A21D 2/36

(52) U.S. Cl. CPC A23L 1/164; A21D 2/36
USPC 426/94; 426/560

(57) ABSTRACT

Generally, a cracker is provided having at least one marbled surface. The marbled surface may include a cracker portion and an inclusion wherein the inclusion composition has a contrasting color, texture, appearance and/or taste when compared to the dough composition.

### CROSS-REFERENCE TO RELATED APPLICATION

This application claims benefit of U.S. Provisional Application No. 61/533,075, filed Sep. 9, 2011, which is hereby incorporated herein by reference in its entirety.

### FIELD

The present application generally relates to crackers and/or crisps having one or more marbled surfaces. More particularly, the present application relates to crackers having a marbled surface created by one or more inclusions.

### BACKGROUND

Crackers, chips and crisps may be prepared in a variety of ways using traditional dough-based ingredients. Further, crackers and chips have been produced using pureed or powdered materials such as vegetables, fruits, and other inclusions. By including vegetables, the overall nutritional value of the cracker may be improved. For example, vegetables include various vitamins, minerals and macronutrients to improve the nutritional value of the product. Further, the pureed or powdered vegetables may also provide flavors and other organoleptic properties to the product.

However, these products generally are prepared such that the pureed or powdered vegetables are evenly dispersed throughout the cracker dough and have such a small particle size that the vegetable material may not be visible, only appear as small flecks, or otherwise only minimally affect the color or texture of the product. The purees or powders result in loss of product identity and structure of the fruit or vegetable when included in the dough. Therefore, the resultant product may not be very distinguishable from other products which do not contain vegetable materials. Moreover, the taste profile may be relatively bland as the vegetable materials are generally spread evenly throughout the cracker in relatively low concentrations.

In some cases, non-uniform snacks have been proposed by forming a variegated snack product by comingling two different dough portions where each dough portion includes a puree of fruit. However, this approach still results in evenly dispersing the puree throughout the dough portion(s) resulting in the same loss of identity and structure as the fruit or vegetables described above.

### SUMMARY

In one approach, a cracker having a marbled surface is provided with visually identifiable pieces smeared on one or more surfaces of the cracker. The cracker includes a cracker portion formed from a dough composition with flour, starches, sugars, oil, flavorings, and leaveners. Once heated, cooked, baked, fried, and the like, the dough composition has a cracker appearance. The cracker also includes an inclusion portion having inclusions with that remain as visually identifiable pieces of the inclusions on the cracker surface. In one aspect, the inclusions remain intact and smeared about a surface of the cracker such that an inclusion appearance has at least one of a contrasting color, shading and texture when compared to the cracker portion. In this aspect, the inclusions generally have about 2 to about 60 percent sugar, and in other cases, about 20 to about 60 percent sugar, which tends to allow the inclusions to remain intact and visually identifiable pieces of the inclusions on the cracker surface. The cracker also has at least a portion of each of the cracker portion and the inclusion portion being visible on the marbled surface. The inclusion portion forming at least one contiguous inclusion or piece covering at least about 1 percent of the marbled surface where at least one of the visually identifiable pieces of the inclusions has a smeared portion on the cracker surface and an embedded portion extending into a body of the cracker.

In another approach, a method for making a cracker having a marbled surface is described. The method includes pre-hydrating a plurality of dehydrated vegetable pieces to form hydrated vegetable pieces. Then, the hydrated vegetable pieces are blended into a dough composition comprising flours, starches, sugars, oil, flavorings, leaveners. The dough is then laminated as a combined mixture to provide a laminated mixture. Thereafter, the laminated mixture is passed through one or more rolls to create a sheet having a marbled surface formed by at least a portion of the hydrated vegetable pieces smeared on the surface of the crackers. In one approach, at least a portion of each of the dough composition and the inclusion composition being visible on the marbled surface such that the inclusion composition forms at least one contiguous inclusion covering at least about 1 percent of the marbled surface. In one approach, the smeared, marbled surface is possible because the method includes a step of passing the formed composition through a steam curtain and then into an oven, which tends to allow the higher moisture inclusions and dough to be effectively baked, cooked, dried, or heated in the oven.

### BRIEF DESCRIPTION OF THE DRAWINGS

For the purpose of facilitating an understanding of the subject matter sought to be protected, there are illustrated in the accompanying drawings embodiments thereof, from an inspection of which, when considered in connection with the following description, the subject matter sought to be protected, its construction and operation, and many of its advantages should be readily understood and appreciated.

FIG. 1A is a perspective view of one side of an exemplary marbled cracker;

FIG. 1B is a perspective view of a second side of the exemplary marbled cracker of FIG. 1A;

FIG. 1C is a cross-sectional view of an exemplary marbled cracker; and

FIG. 2 is a process flow diagram representing one process for forming marbled crackers or crisps.

### DETAILED DESCRIPTION

Generally, a cracker is provided having at least one marbled outer surface including discretely identifiable inclusions that maintain at least a portion of its product identity, structure, and/or physical consistency of the inclusion. That is, for example, if the inclusion is a vegetable piece, it maintains at least a portion of its size, shape, and/or piece integrity so that it remains visually identifiable as the vegetable in and/or on the finished cracker product. In one aspect, the marbled surface may include a cracker portion formed of a dough composition and an inclusion portion smeared or spread about at least one of the outer surfaces and wherein the inclusion maintains characteristics and identity of the inclusion source and has a contrasting color, texture, appearance and/or taste when compared to the cracker and dough portion. The dough composition and inclusion composition may be combined such that at least a portion of each of the dough composition and the inclusion composition are visible on the marbled surface. In one form, the inclusion composition forms at least one contiguous inclusion smeared or otherwise covering at least about 1 to about 5 percent of the outer surface area of a cracker surface. In another form, one or more inclusions (in total or in combination) could cover from about 5 to about 50% of the total outer surface area of one side of the cracker's outer surface to form the marbled appearance. In another form, some of the inclusions may extend over a portion of the cracker outer surface to define the marbled appearance and, at the same time, extend internally to the cracker. In another form, some inclusions may form a portion of the marbled surface on both sides of the cracker and extend through an internal portion of the cracker body at the same time. In yet another form, the cracker may have both inclusions forming a marbled surface as well as whole inclusions contained completely within the body of the cracker that are not smeared or visible on a surface.

Further, the inclusions may have a contrasting color when compared to the dough composition. For example, the dough composition may have a generally light color whereas the inclusions may have a dark color such as, but not limited to, red, orange, yellow, or green. Additionally, the inclusions may provide not only color contrast but also unique texture and taste profile. Furthermore, the inclusions may enhance the nutrition of the cracker by way of vitamins, minerals, and other micro nutrients. In one form, the inclusions give the cracker a generally marbled appearance that may be more attractive and believable to consumers. Further, the marbling-appearance enhances consumer appeal and nutritional properties.

In another aspect, the cracker may be processed in a variety of different ways and may include various combinations of different ingredients. In one form, a vegetable composition, such as sweet potato, may be included as granules, pieces, or particles in the inclusion composition. In this regard, the vegetable composition may be a dehydrated material that is then rehydrated when combined with the dough composition. The combined composition is then passed through one or more rollers to be laminated.

The embedded inclusions in the dough are effective to give the marbled appearance. By one approach, the inclusions are initially dehydrated and hydrated during processing to an effective moisture content that is suitable to sufficiently soften the inclusions but still allow the inclusion to maintain its physical particle identity when processed. The hydrated inclusions are conditioned and then flattened during a sheeting process using reduction rolls to form the marbling. By one approach, the inclusions may include pieces of vegetables with high levels of sugar, such as pieces of root vegetables including sweet potato, beet roots, carrots, and the like. The inclusions may also include other types of vegetable pieces and may include pieces of legumes such as beans, peas, and the like. In other cases, the inclusions may include pumpkin, squash, and zucchini, and mixtures thereof.

It has been discovered that not all vegetables are suitable for forming the marbled surface appearance. In general, vegetables with high levels of sugar are most suitable for forming the marbled surface. For example, vegetable with at least about 15 percent, in some cases at least about 20 percent sugar are effective in forming a marbled appearance. In other cases, the vegetables may include about 15 to about 60 percent sugar, and in yet other cases, about 20 to about 60 percent sugar. In yet other approaches, the vegetables may have about 2 to about 60 percent sugar.

In another approach, the production process may involve hydrating and softening the inclusion pieces under elevated temperatures prior to dough formation. The process allows manufacturing using high levels of the inclusions. Optionally, the inclusions may be added to the dough or during lamination/sheeting stage. The marbled inclusions become part of the product matrix that are noticeable and visible.

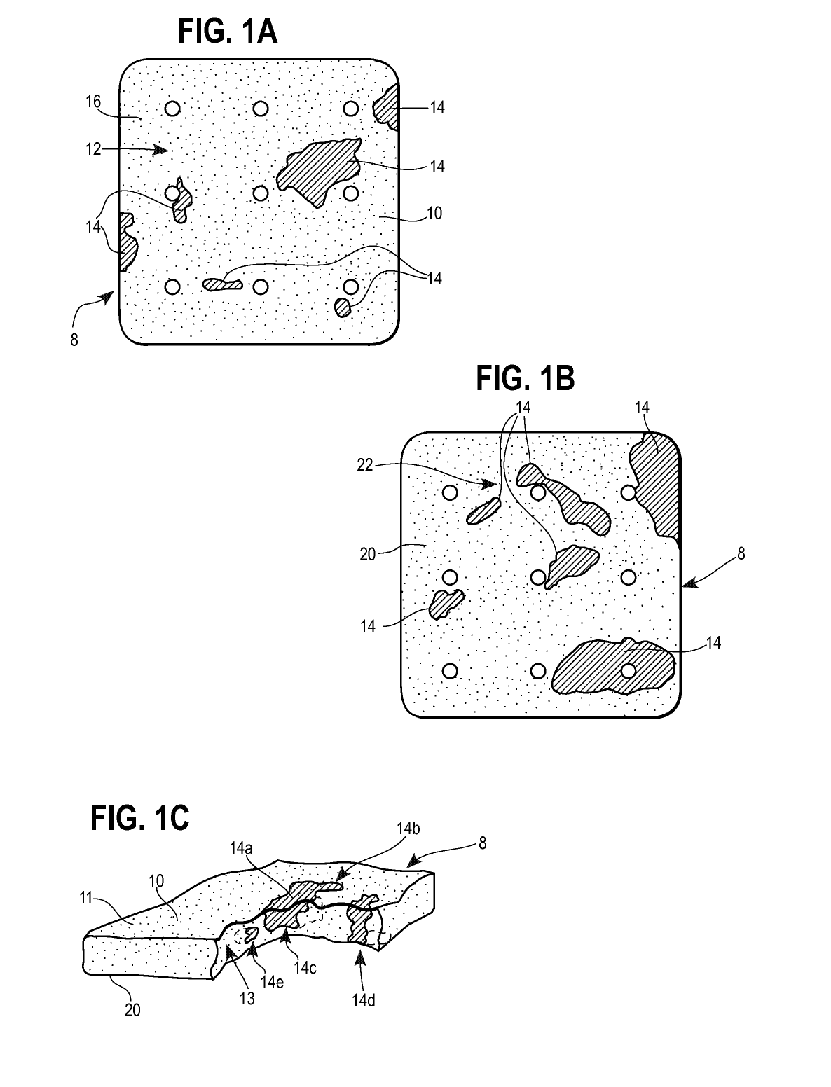

Turning to more of the specifics and first referring to FIGS. 1A-1C, a cracker 8 is illustrated having opposing side surfaces including a first side 10 with a marbled surface 12. The marbled surface 12 generally includes one or more inclusions 14 incorporated in a cracker portion formed from a dough 16. By one approach, the cracker has a single dough or cracker portion forming a continuous cracker matrix with the inclusions therein. In one form, the dough 16 has a baked, fried, or otherwise cooked dough appearance, such as a light color along with a relatively smooth texture. The inclusions 14 may have a contrasting appearance when compared with the dough 16. For example, the inclusions 14 may have a dark color, such as red, orange, brown, yellow, or green depending on the source of the inclusion. Further, the inclusions 14 may have a rougher texture when compared with the dough 16. However, it should be understood that the inclusions 14 may have any contrasting appearance when compared with the dough appearance. The inclusions have a size and a shape such that they remain visually identifiable and maintain at least a portion of its physical integrity from the source providing the inclusion.

The inclusions 14 may also have an expanded, elongated, or smeared-type appearance on the outer surface of the cracker such that the edges of the inclusions 14 are ragged and not necessarily smooth. So formed, the inclusion still retains an integrity of its source material so that the inclusions still maintain a contiguous portion thereof. Additionally, the inclusions 14 need not have a solid color, but instead may have color variations along with other colors interspersed therein. For example, the inclusions may have a generally orange color, but may also include darker spots which may be indicative of deeper inclusions. The color differences may vary within a single inclusion 14 and may also vary from amongst the plurality of inclusions 14. Similarly, the texture of the inclusion 14 may also vary within a single inclusion 14 and may also vary amongst the plurality of inclusions.

As shown in FIG. 1B, a second or opposite side 20 of the cracker 8 from FIG. 1A is shown. In one form, the second side 20 also has a generally marbled surface 22 including a plurality of inclusions 14. The inclusions 14 on the second side 20 need not be the same inclusions 14 as on the first side 10.

FIG. 1C is a cross-sectional view of the cracker 8 showing that the inclusions 14 may not only extend about an outer surface 11 of the cracker 8, but one or more of the inclusions may also extend at least partially internally to a body 13 of the cracker 8. For example, inclusion 14a may have a portion 14b that is smeared about the outer surface 11 and the same inclusion 14a may also have a portion 14c that is embedded or extends internally to the cracker body 13. However, some of the inclusions, such as inclusion 14d shown in FIG. 1C may extend from the first side 10 internally through the cracker body 13 to the second side 20 such that the same inclusion 14d may be visible on both sides 10 and 20. That is, one or more inclusions may have a portion visibly identifiable and/or smeared on each of the opposing cracker surfaces with an interconnecting portion extending through and embedded in the cracker body as shown by the exemplary inclusion 14d. In other cases, some of the inclusions, such as inclusion 14e, may be wholly contained within the body 13 of the cracker. The cracker 8 may contain any combination of the various types of inclusions.

The inclusions 14 are generally un-evenly sized pieces, granules, or particles of vegetables. By one approach, the pieces may have a size characterized as a −3+10 US standard mesh size. That is, 100 percent of the pieces may fall through a US 3 standard mesh and 100 percent of the pieces may be retained in a US 10 standard mesh sieve. In another approach, the unevenly sized pieces may vary in size from about 1/16 inch to about ¼ inch; however other sizes may be used depending on the application, vegetable, or other inclusion. Further, the inclusions 14 may cover about 5 to about 50 percent of the exposed surface area of the first side 10 and/or the second side 20 and, at the same time, may also cover about 5 to about 50 percent of a cross-section of the cracker and, in some cases, about 5 to about 30 percent of a cracker cross-section such that the cracker has a greater portion of the inclusions smeared on the outer surfaces than within a body of the cracker.

By one approach, an effective inclusion to form a marbled appearance may also be related to the size and thickness of the cracker. For instance, the size of the inclusion may be related to the cross-sectional thickness of the final cracker. Thus, an inclusion prior to mixing in the cracker dough ranging in size characterized by the mesh sizes above or from about 1/16 inch to about ¼ inch may be used in a cracker having a final thickness of about 0.08 inches to about 0.2 inches in order to achieve the desired marbled appearance. Selection of such cracker thickness and pre-inclusion sizes is effective to permit sufficient inclusion material to be smeared on the surfaces. If the inclusion is too small or the cracker is too thick, then the inclusion may not form the marbled appearance because it may not have sufficient inclusion portions exposed on the outer surfaces. Thus, in one approach, the marbled crackers may have a marbling ratio of inclusion size to cracker thickness of about 0.7 to about 1.5 in order to achieve the desired marbled surface effects.

As mentioned above, the inclusions may be root vegetables such as sweet potatoes, carrots, beets, and the like. The inclusions may also be legumes such as peas, beans, and the like. To be an effective inclusion, the vegetables generally include effective levels of starch, sugar, and fiber that enable the vegetable to sufficiently hydrate and soften to enable smearing or spreading on the cracker surface, but at the same time, the starch, sugars, and fiber also enable to the inclusion to remain intact in the finished cracker and retain its structural integrity and/or its product or piece identity after hydration and smearing. As mentioned above, the inclusion may have about 15 to about 60 percent sugar. Effective inclusions may also have less than about 12 percent starch, such as about 4 to about 12 percent starch. Suitable inclusions also have at least about 3 percent fiber and in some cases about 3 to about 10 percent fiber. The inclusions may also be dehydrated prior to incorporation into the dough. In some approaches, the inclusions may have about 0.5 to about 5 percent moisture prior to hydration and incorporation into the cracker or dough.

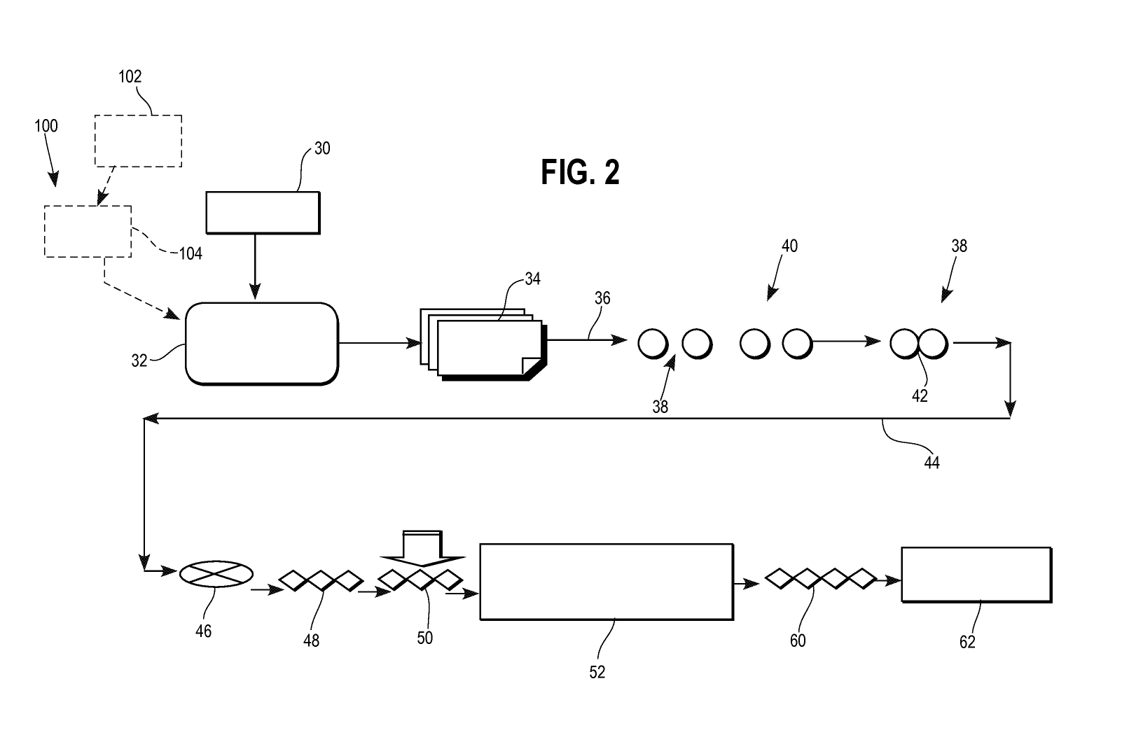

Turning to FIG. 2, one exemplary method for manufacturing the marbled cracker is illustrated. In this exemplary method, the ingredients 30 may be first combined in a dough mixer 32 to form dough where inclusions are hydrated in a manner effective to maintain inclusion structure and integrity. This may occur in a single dough mixing step 32 or may occur in a two-step process where dehydrated inclusions are pre-hydrated with a portion of the process water. The mixed dough may then be laminated 34 to formed sheets of dough that are then processed through one or more reducing rolls 38, which may include initial reducing rolls 40 and final gauge rolls 42. By one approach, it is the final gauge rolls that sets the cracker thickness and forms the marbled surface by smearing at least a portion of the inclusions exposed on the outer surfaces of the sheeted dough. The dough from the final gauge rolls having a marbled surface is then sent to a cutter 46, an optional salting station 48, and then through an optional steam curtain 50 prior to a baking oven 52. As the baked crackers emerge from the oven, they may have an application of oil or other seasonings at step 60 prior to packaging 62. Each of these process steps will be descried in more detail below.

The dough may include a variety of ingredients that may be combined in a variety of manners. For example, the dough composition may include flour, water, starches, leavening agents, oils, seasonings, flavors, and the inclusions. More specifically, the dough composition may include flour, water, salt and seasonings, sodium bicarbonate, oil, corn starch, mono-calcium phosphate and other materials. By one approach, an exemplary dough composition is provided in Table 1 below. When including the inclusions, it has been discovered that in some instances it may be advantageous to use higher starch levels in the dough than commonly used in crackers and chips. The higher starch levels may aid in forming the desired cracker or chip-like texture when high levels of inclusions are included in the dough. In some approaches, an effective amount of starch in the dough to an amount of inclusion(s) in the dough is about 0.2 to about 4 and, in other approaches, about 0.5 to about 2. Such ratio of dough start to inclusion amount permits high levels of inclusions suitable for smearing on a surface yet retains the ability to form the desired cracker or chip-like texture. As used herein, cracker generally refers to a cracker or chip, and in some cases, other dough based snack foods that are processed through sheeting and lamination.

TABLE 1
Exemplary Composition

| Ingredients | Purpose | Min, % | Max, % |
|---|---|---|---|
| sugar | Sweetness, plasticizer, | 0 | 20 |
| | color | | |
| Starch | Dough structure, texture, | 1 | 20 |
| | cell structure development | | |
| | (may include various | | |
| | combinations of corn | | |
| | and/or potato starch) | | |
| Inclusions | Texture, taste, flavor, | 5 | 50 |
| | appearance | | |
| Water | Dough formation, | As needed | |
| | plasticizer, hydration, | | |
| | texture | | |
| Oil | Texture, taste, processing | 1 | 10 |
| | aid, dough condition | | |
| Sugar Syrup | Sweetness, color, | 0 | 8 |
| | plasticizer | | |
| Flour | Dough strength, texture, | 25 | 75 |
| | nutrition, taste | | |
| Leavening | Cell structure, pH | 0.5 | 5 |
| | development | | |
| Flavors | Taste | 0.5 | 6 |

The ingredients include an inclusion or an inclusion composition having a plurality of visually identifiably pieces or particulates of vegetables. The inclusion composition may include pieces, such as diced pieces of vegetables. In one form, the inclusion composition includes vegetable pieces where the vegetable contains greater than about 15 percent sugar. For example, the vegetable pieces may include about 2 to about 60 percent sugar, and in some cases, about 20 to about 60 percent sugar. While not wishing to be limited by theory, it is believed that such range of sugar in the vegetables may aid in forming the marbled appearance while still retaining integrity of the vegetable pieces. For example, it is believed that such levels of sugar in the vegetables aid with compression and flattening of the pieces while still maintaining vegetable integrity. In another form, the inclusion composition may also include dehydrated vegetables that are more suitable for storage that may then later be rehydrated during processing. Suitable inclusions include, but are not limited to root vegetable such as sweet potato, yams, beet roots, tubers, carrots and mixtures thereof. Additional details regarding these compositions and orders of addition will be described in more detail below.

When prepared using dehydrated vegetable pieces, it may be preferable to pre-hydrate 100 the dry inclusion pieces 102 in water in order to soften the pieces prior to mixing the vegetable pieces with the remaining dough ingredients as shown by the hashed lines in FIG. 2. By one approach, a portion of the process water 104 used to make the cracker dough is blended with the dehydrated inclusion pieces 102. By one approach, about 50 to about 60 percent of the formulation's water requirements are blended with the dehydrated vegetable pieces in this pre-hydration step. The dehydrated vegetables may then be hydrated to about 40 to about 50 percent moisture prior to blending with the other dough ingredients. In another approach, the water used in this pre-hydration step may be at least about 140° F., and preferably about 150 to about 170° F. Such water temperatures are selected to quickly hydrate the vegetables and also to maintain piece integrity. Higher water temperatures may negatively affect the physical integrity of the vegetable pieces. In order to maintain inclusion integrity in the final product, selection of inclusion characteristics (i.e., sugar, fiber, moisture, and the like as discussed above), as well as selection of processing conditions, are some factors discovered to be desirable to achieve the smeared crackers herein. With pre-hydration, the inclusion composition is usually softened and still maintains piece integrity so that when it is combined with the dough composition, the separation of the materials is minimized. If the inclusion composition is substantially harder than the dough composition, it is possible that the materials may separate during processing, resulting in gaps and holes in the finished product. Generally, the inclusion material is hydrated and softened such that it has a moisture content of about 40 to about 50 percent, and in some cases, about 45 to about 50 percent.

After pre-hydrating the inclusion pieces, the hydrated inclusions and mixed with the other dough ingredients and the remaining portion of the water. While not wishing to be limited by theory, this two-step hydration and mixing may be helpful to properly hydrate the starches in the inclusions. If the inclusions are hydrated in a single step with all the process water, there may be competition between the inclusions and the other ingredients in the formula or dough for the water. In such case, the inclusions may not be properly hydrated. When the pre-hydrated inclusions are added with the remaining dough ingredients, the second portion of the process water is then added to the dough. This second portion may be about 40 to about 50 percent of the water requirements. It is also believed that surface moisture from the pre-hydrated inclusions may also contribute water to the dough formulation.

By one approach, the dough may include about 95 percent dough ingredients to about 5 percent inclusions up to about 50 percent dough ingredients to about 50 percent inclusions.

In the dough mixer, the hydrated inclusions and other dough ingredients are mixed effective to properly blend the ingredients but maintain inclusion integrity at the same time. This may be accomplished, in one approach, by using about 20 to about 60 RPMs for a total mix time of about 6 to about 12 minutes. Other speeds and times may also be used so long as inclusion integrity and structure is maintained. The finished dough may have a temperature of about 110 to about 130° F., which is effective to properly blend the dough ingredients and still maintain the inclusion integrity at the same time. In some approaches, the mix procedure may also add oil in a separate stage at the end of dough mixture, this may be used to help with dough stickiness and processing.

It should also be noted that the dough composition need not be combined with the inclusion composition in the dough mixer 32. Instead, the dough composition may be combined with the inclusion composition at a lamination stage 34. In this form, only the ingredients for the dough composition will be added at the dough mixer 32. However, the inclusion composition may be combined with the dough composition at the dough mixer 32. Further, it should be noted that components of the dough composition may alternatively be provided in the inclusion composition and vice verse. For example, water may be provided in one or both of the dough and inclusion compositions. However, it has been found that in many cases, depending on the inclusion composition, it may be desirable to incorporate at least a portion of the total water in the dough composition as the inclusion composition may absorb most, in not all, of the water such that the dough composition may not be provided with sufficient water.

In some instances, the flour and hydrated inclusion portions may be thermally treated during dough mixing. Thermal treatment may help hydrate the inclusions and gelatinize or cook at least portions of the starch in the wheat flours. This treatment tends to impart a more chip-like texture to the finished product. By one approach, thermal treatment may be injecting steam at about 15 to about 40 psi under atmospheric pressure for about 5 to about 15 minutes while mixing dough ingredients in the dough mixer in order to gelatinize and/or cook the materials. The resultant dough may be about 130 to about 150° F.

After dough preparation 32, the dough composition is laminated and sheeted through a series of reducing and gauge rolls. Regardless of the dough preparation process described above, the dough is combined with inclusion composition by the time the materials pass through the lamination stage 34 to form a combined mixture. The mixed dough is dumped out of the mixer and processed through a series of rolls that form a sheet about ¼ inches thick (in one approach). The sheet may then be folded over into 3 to 5 total layers totaling about 1 to about 1.25 inches thick. Then, the folded dough is sent through a series of reduction rolls to the final thickness. Generally, the lamination stage 34 forms the combined mixture into one or more laminated mixtures or sheets of dough with inclusions therein.

The laminated mixture is then transferred, via line 36, to one or more reducing rolls 38 for reducing the thickness of the laminated sheets of dough. The rolls 38 can include a variety of different types of rolls. For example, as shown in FIG. 2, the process includes reducing rolls 40 and gauge rolls 42. Generally the reducing rolls are a pair of opposing rolls having a gap thickness of about ¼ (in one approach) to initially reduce the thickness of the laminated sheet. The reduced thickness laminated mixture may then travel to the final gauge rolls 42 that are a pair of opposing rolls having a gap thickness of about 0.04 inches to reduce the thickness to its final, unbaked thickness and produced a continuous dough sheet having the marbled appearance. Other gap sizes may also be used as needed. The final gauge rolls and the size of the inclusions are such that these rolls produce the marbled appearance of the inclusions in the dough. By one approach, the reducing rolls having a smooth surface with the top roll on the finish gauge roll turning about 15 to about 25 percent faster to release the dough sheet from the top roll.

As noted above, the inclusion composition is generally softened so that separation is minimized between the dough composition and the inclusion composition. If the inclusion composition is much harder or does not have proper water content, the compositions may separate. Further, as the inclusion composition is softened, it is more suitable for spreading or streaking, such as when it is passed through the rollers 38. If the inclusions are not properly hydrated as described above, they may not form the desired marbled appearance or may not even make it through the final gauge rolls. If not properly hydrated, the inclusions may be too hard and get stuck at the final gauge rolls causing streaking in the dough.

The final gauge rolls are effective to form the marbled appearance on the outer surface of the laminated sheets. By one approach, it should be noted that as the laminated material passes through the rollers 38, the rollers provide sufficient pressure to cause the inclusion composition to spread or streak, but not so much pressure such that the inclusion composition becomes indistinguishable from the dough composition. In this regard, generally the laminated material is not passed through high shear rollers.

After passing through the rollers 38, the material is transferred, as at line 44, to a cutter 46 whereby the material may be cut into desired shapes and sizes to form a cut material. The cut material may then optionally be transferred to a salt stage 48 whereby salt and other flavorings may be added to the cut material. Application of salt and other flavorings at this point may help aid in forming the marbled appearance because salt and oil toppings may help enhance the differences between the dough and inclusion in the finished product.

Further, in another optional step, the cut material may be transferred through a steam curtain 50 prior to entering an oven 52. The steam is provided in an amount and at a temperature effective to help maintain the humidity during the initial heating stages in the oven 52 as described further below. By one approach, the steam curtain includes a series of 3 to 5 steam manifolds that are contained in an enclosure prior to the entrance to the oven. The exit of the steam enclosure includes a hood or other enclosure that covers the product as it exists the steam curtain enclosure and is carried in to the oven. In manner, the hood traps at least a portion of the steam and carriers it into the first zone of the oven. In some approaches, the product is carried by a conveyor belt or other transport through the steam curtain and into the oven. The motion of the transport tends to draw or carry steam from the steam curtain into the first zone of the oven. The steam provides a more optimal baking environment to improve moisture bake out, color, and texture of the finished cracker. By one approach, the steam curtain is placed right before the entrance to the baking oven and the steam nozzles are about 3 to about 6 inches above the product and conveyor belt carrying the product. The steam may be about 5 to about 40 psi and at a temperature of about 180 to about 212° F.

By one approach, the steam is applied via a series of 3 to 5 pipes with injection nozzles about 0.5 to 2 inches apart with inserts that isolate condensate and only allow steam onto the product such that no or substantially no condensate or water accumulates on the cracker surface. The steam curtain includes an enclosure that surrounds the manifolds with an entrance enclosure and an exit enclosure at the entrance and exit of the steam curtain to substantially retain steam within the enclosure. It is believed that the steam carried into the first zone of the oven enhances the relative humidity in the oven and leads to a higher temperature in the first two oven zones.

In the oven, the cut and steamed material is then baked or otherwise cooked at about 275 to about 450° F. for about 3 to about 7 minutes to provide a baked or cooked product. The finished moisture content of the cracker is about 1.5 to about 3 percent.

While not wishing to be limited by theory, the steam curtain 50 is effective to delay dehydration of the outer surface of the cracker in the first zone of the oven to help obtain a more uniform baking or moisture bake out of the cracker. The steam curtain permits a higher temperature in the first oven zone. If the steam curtain is not used, then the outer surfaces of the cracker may dry or bake faster in the initial stages of the oven, which tends to form a crust on the crackers. If a crust forms, it may hinder the moisture bake out and drying of the inner portions of the cracker. By one approach, due to the hydrated inclusions used in the crackers described above, additional water and or steam treatment may be used in the dough preparation steps that would not necessarily be properly baked or dried in the oven if the steam curtain is not used. The dough with the inclusions is generally at about 25 to about 35 percent moisture (in some cases about 30 percent moisture) and may contain as much as 5 to about 20 percent more water than a standard cracker formulation. Thus, the steam curtain is effective in such circumstances to help bake and properly dry the cracker to a final moisture content of about 1 to about 4 percent and controls expansion, which results in a crispier/crunchier texture.

After the oven 52, the cooked product may also be optionally oiled and seasoned, such as at stage 60 prior to being transferred to packaging 62.

Advantages and embodiments of the crackers described herein are further illustrated by the following examples; however, the particular conditions, processing schemes, materials, and amounts thereof recited in these examples, as well as other conditions and details, should not be construed to unduly limit the crackers and methods described herein. All percentages are by weight unless otherwise indicated.

### Example 1

In one form, crackers may be made with wheat flour (unenriched and/or whole grain), starches (potato and/or corn), sugar (granular and syrup), real dried vegetable pieces, salt, seasoning, oil, and leaveners. The starches, granular sugar and dried vegetables can be mixed with hot water (150-180° F.) in the initial mixing phase. This allows the starches to hydrate properly as well as softens the vegetable pieces enough to allow them to process through sheeting without tearing the dough. The remaining ingredients can be mixed to create a finished dough. The dough can be held for about 30 to about 120 minutes, and will be between about 110° F. to about 125° F. Once holding is complete dough can be sheeted.

The dough will proceed through the laminating process followed by a series of 2-3 reduction rolls. The crackers can be then cut and salted. A series of 3-5 steam manifolds are set up at the entrance to the oven, with a hood/enclosure to ensure the steam stays on the product and enters the oven. The crackers can pass through the steam and into the oven for baking. The steam helps maintain a more optimal baking environment to improve moisture bake out, color and texture of the finished cracker. The finished crackers are oiled and then go through a post oven drier and on to packaging. Alternatively, the crackers may be baked/dried and include a post baking application of oil. The finished crackers are dump filled into bags that are then fed into cartons.

### Example 2

In this Example, a non-thermally processed sweet potato containing cracker was prepared using the components listed in Table 2. After baking, salt and oil are applied to the cracker. The sweet potato is dehydrated un-evenly sized pieces characterized as −3+10 as described above.

TABLE 2
Vegetable Cracker Formula

| Description | ~Weight, lbs |
|---|---|
| Dough (pre bake) | |
| Sweet Potato-Dehydrated | 32 |
| Sweetener | 9 |
| Starch-Potato | 15 |
| Oil | 6 |
| Sugar Syrup | 5 |
| Leavening agents | 3 |
| Seasoning and Flavor | 1.6 |
| Water | 50 |
| Flour | 100 |

The sweet potato was first hydrated with a portion of the water. Then the pre-hydrated sweet potatoes were combined with the remaining ingredients and mixed for 6 to 12 minutes at about 20 to 60 RPM. Water temperature was about 140 to about 180° F.

### Example 3

In Example 3, a thermally processed sweet potato cracker was prepared using the components listed in Table 3.

TABLE 3
Sweet Potato Thermally Processed

| | Percent |
|---|---|
| Ingredients | of Dough |
| Group 1 | |
| Wheat Flour | 34.93% |
| Whole Wheat Flour | 12.87% |
| Sweet Potato Granules | 15.32% |
| ( 3/16″ or smaller) | |
| Salt | 0.41% |
| Water | 27.57% |
| Group 2 | |
| Starch | 7.36% |
| Leavening | 0.32% |
| Group 3 | |
| Oil | 1.23% |

Generally, the sweet potato granules were hydrated in water at a temperature of about 70 to about 75° F. for approximately 10-15 minutes. Next, the flour, whole wheat flour, salt, vegetable granules and room temperature water (about 70 to 75° F.) were combined in a dough mixer (Shaffer) to gelatinize/cook the material by injecting steam to approximately 160-180° F. with mixing at 20 RPM for 10 to 15 minutes.

Next, the ingredients listed in Group 2, except for the oil, were added to the gelatinized/cooked material and allowed to mix at 20 RPM for 2 minutes. Then the oil was added and mixed at 20 RPM for 2 minutes. The dough temperature was approximately 130-150° F. The dough was then sheeted without lamination and then baked in an over to a maximum moisture content of 4 percent. The material was then finished in a dielectric or post convection dryer to a moisture content of 1-3 percent. This Example resulted in a chip-like product having a marbled surface appearance.

### Example 4

In Example 4, a non-thermally processed sweet potato cracker was prepared using the components listed in Table 4. The sweet potato pieces were similar in size to Example 2.

TABLE 4
Sweet Potato Non-Thermally Processed

| | Percent |
|---|---|
| Ingredients | of Dough |
| Group 1 | |
| Sweetener | 4.25% |
| Starch | 6.8% |
| Sweet Potato | 14.3% |
| Group 2 | |
| Water | 22.57% |
| Group 3 | |
| Oil | 2.9% |
| Sugar Syrup | 2.4% |
| Group 4 | |
| Flour | 44.6% |
| Leavening | 1.4 |
| Flavor and Seasoning | 0.6% |

Generally, the sweetener, starches (which may be potato, corn, or combinations thereof) and sweet potato pieces are combined and mixed for thirty seconds. The water at 150° F. is then added and mixed on high (60 RPM) for about 3 minutes. Next, the oil and syrup are added and mixed on high (60 RPM) for about 1 minute. Then, the flour (which can be unenriched flour, graham flour, and/or combinations thereof); leavening (which can be sodium bicarbonate, calcium bicarbonate, and/or mixtures thereof); and other ingredients and additional water (about 1 pound) are added a mixed on high for 7 minutes.

### Example 5

In Example 5, another non-thermally processed sweet potato cracker was prepared using the components listed in Table 5.

TABLE 5
Sweet Potato Non-Thermally Processed

| | Percent |
|---|---|
| Ingredients | of Dough |
| Group 1 | |
| Sweetener | 4.1% |
| Starch | 6.7% |
| Sweet Potato | 15.8% |
| Group 2 | |
| Water | 22.1% |
| Group 3 | |
| Oil | 2.9% |
| Syrup | 2.4% |
| Group 4 | |
| Flour | 43.8% |
| Leavening | 1.37 |
| Flavors and Seasoning | 0.56% |

### Example 6

In this Example, another non-thermally processed sweet potato cracker was prepared using the components listed in Table 6.

TABLE 6
Sweet Potato Non-Thermally Processed

| | Percent |
|---|---|
| Ingredients | of Dough |
| Group 1 | |
| Sweetener | 4.0% |
| Starch | 6.5 |
| Sweet Potato | 16.6% |
| Group 2 | |
| Water | 22.8% |
| Group 3 | |
| Oil | 2.8% |
| Syrup | 2.35% |
| Group 4 | |
| Flour | 42.7% |
| Leavening | 1.33 |
| Flavor and Seasoning | 0.55 |

The matter set forth in the foregoing description and accompanying drawings is offered by way of illustration only and not as a limitation. While particular embodiments have been shown and described, it will be apparent to those skilled in the art that changes and modifications may be made without departing from the broader aspects of applicants' contribution. The actual scope of the protection sought is intended to be defined in the following claims when viewed in their proper perspective based on the prior art.

What is claimed is:

1. A cracker having a marbled surface, the cracker comprising:
a cracker portion formed from a dough composition comprising flour, starches, sugars, oil, flavorings, and leaveners, the dough composition having a cracker appearance;
an inclusion portion having inclusions with about 2 to about 60 percent sugar so that the inclusion portion includes visually identifiable pieces of the inclusions, the inclusions remaining intact and smeared about a surface of the cracker such that an inclusion appearance has at least one of a contrasting color, shading and texture when compared to the cracker portion; and
at least a portion of each of the cracker portion and the inclusion portion being visible on the marbled surface, the inclusion portion forming at least one contiguous inclusion covering at least about 1 percent of the marbled surface where at least one of the visually identifiable pieces of the inclusions has a smeared portion on the cracker surface and an embedded portion extending into a body of the cracker.

2. The cracker of claim 1 wherein the inclusion composition has a contrasting color when compared to the cracker portion.

3. The cracker of claim 1 wherein the inclusion composition has a different texture and taste when compared to the cracker portion.

4. The cracker of claim 1 further comprising a plurality of contiguous inclusions covering a total of about 5 percent to about 50 percent of the marbled surface.

5. The cracker of claim 1 wherein the inclusion composition comprises at least one vegetable.

6. The cracker of claim 1 wherein at least one of the visually identifiable pieces of the inclusion composition extends from the marbled surface towards an interior portion of the cracker and remains intact and smeared about an opposite surface of the cracker so that the at least one visually identifiable piece is visually identifiable on opposing surfaces of the cracker.

7. The cracker of claim 1 wherein the cracker has a select ratio of inclusion size to thickness of about 0.7 to about 1.5 to form the inclusion appearance.

8. The cracker of claim 1 wherein the cracker has a ratio of starch to amount of inclusion of about 0.2 to about 4 to permit the inclusions to remain visually identifiable and smear on the surface yet retain a cracker texture.

9. A method for making a cracker having a marbled surface, the method comprising:
pre-hydrating a plurality of dehydrated vegetable pieces to form hydrated vegetable pieces;
blending the hydrated vegetable pieces into a dough composition comprising flour, flours, starches, sugars, oil, flavorings, leaveners,
laminating the combined mixture to provide a laminated mixture;
passing the laminated mixture through one or more rolls to create a sheet having a marbled surface formed by at least a portion of the hydrated vegetable pieces smeared on the surface of the crackers, at least a portion of each of the dough composition and the inclusion composition being visible on the marbled surface, the inclusion composition forming at least one contiguous inclusion covering at least about 1 percent of the marbled surface.

10. The method of claim 9 further comprising the steps of passing the formed composition through a steam curtain and then into an oven.

11. The method of claim 9 wherein the laminated mixture is passed through at least one pair of rolls whereby the hydrated vegetable pieces will smear upon contact with the rolls to form the marbled surface.

12. The method of claim 9 wherein the dehydrated vegetable pieces include one or more vegetable materials in the form of pieces in the range of −3+10 as determined by standard US sieve sizes.

13. The method of claim 12 wherein the pieces include dehydrated vegetable pieces that are rehydrated prior to laminating the combined mixture.

14. The method of claim 12 wherein the vegetable material is selected from the group consisting of sweet potatoes, yams, beet roots, tubers, carrots and mixtures thereof.

15. The method of claim 12 wherein the vegetable material contains at least 2 percent sugar.

16. The method of claim 12 wherein the vegetable material contains at least 15 percent sugar.

17. The method of claim 10 wherein the dough composition with the hydrated vegetable pieces has about 25 to about 35 percent moisture and after drying about 1 to about 4 percent moisture.

18. The method of claim 9 wherein the hydrating water is greater than about 140° F. so that the vegetable pieces remain visually identifiable in the dough composition.

19. The method of claim 10 wherein the steam pressure is about 5 to about 40 psi provided from steam nozzles positioned about 3 to about 6 inches above the surface of the crackers.
